(19) United States
(12) Patent Application Publication
(10) Pub. No.: US 2012/0161713 A1
(43) Pub. Date: Jun. 28, 2012

(54) VEHICLE ENERGY HARVESTING APPARATUS AND ENERGY MANAGEMENT METHOD THEREOF

(75) Inventors: Jung-Sook KIM, Daejeon (KR); Dong-Yong Kwak, Daejeon (KR); Dong-Sun Lim, Daejeon (KR)

(73) Assignee: ELECTRONICS AND TELECOMMUNICATIONS RESEARCH INSTITUTE, Daejeon (KR)

(21) Appl. No.: 13/334,820

(22) Filed: Dec. 22, 2011

(30) Foreign Application Priority Data
Dec. 22, 2010 (KR) 10-2010-0132880

(51) Int. Cl. H02J 7/00

(52) U.S. Cl. 320/134

(57) ABSTRACT

Disclosed herein is a vehicle energy harvesting apparatus. The vehicle energy harvesting apparatus includes a battery unit, an energy collection unit, an external charging interface, and an energy management unit. The battery unit is formed in a vehicle. The energy collection unit is provided on one side of the vehicle, and configured to generate renewable power by collecting renewable energy. The external charging interface is formed on one side of the vehicle in order to exchange power between the battery unit and a smart grid. The energy management unit is configured to perform control such that the renewable power of the energy collection unit is stored in the battery unit, and such that power is exchanged between the battery unit and the smart grid using the external charging interface.

### CROSS REFERENCE TO RELATED APPLICATION

This application claims the benefit of Korean Patent Application No. 10-2010-0132880, filed on Dec. 22, 2010, which is hereby incorporated by reference in its entirety into this application.

### BACKGROUND OF THE INVENTION

1. Technical Field

The present invention relates generally to a vehicle energy harvesting apparatus and energy management method thereof. In particular, the present invention relates to a vehicle energy harvesting apparatus and energy management method thereof which can effectively connect the battery of a vehicle to a smart grid, and can use the battery of the vehicle as the surplus power storage device of the smart grid.

2. Description of the Related Art

The amount of energy consumed for transportation assumes 20% of the total annual energy consumption in Korea, whereas vehicle driving efficiency assumes very low percentages, that is, 15 to 30%. Therefore, technologies for collecting the energy in a vehicle, that is, technologies which can collect a large amount of energy wasted by a vehicle and which can collect and integrate various types of environmental energy have been being required.

Further, smart grid technologies, that is, next generation intelligent power networks which optimize energy efficiency by applying information technology to existing power networks and performing two-way information exchange between power suppliers and power consumers, are receiving attention.

Further, with the increasing introduction of renewable energy throughout the world, an explosive demand for energy storage is expected. Although pumping-up power generators were developed to be a technology for storing surplus power, they have not yet been popularized and used and do not store surplus power at present. It is difficult to estimate and adjust the amount of power of renewable energy because of its features. That is, the amount of renewable energy generation varies depending on weather and on the circumstances. In order to provide renewable energy to a power system and effectively use the renewable energy, it is necessary to store the generated energy. However, there is the problem in that a large amount of effort and cost are required to build additional storage equipment used to store energy.

### SUMMARY OF THE INVENTION

Accordingly, the present invention has been made keeping in mind the above problems occurring in the prior art, and an object of the present invention is to effectively collect environmental energy and energy which was discarded from a vehicle.

Another object of the present invention is to connect the high-capacity battery of a vehicle to a smart grid, thereby enabling power to be effectively and intelligently stored, operated, and managed.

Further another object of the present invention is to enable the high-capacity battery of a vehicle to be used as a device for storing power produced by an apparatus for generating renewable energy in which the estimation and adjustment of the amount of generating power are difficult. That is, the object of the present invention is to enable the high-capacity battery of a vehicle to be used as a device for storing surplus power generated by a smart grid.

Still another object of the present invention is to stably provide renewable energy generated by a smart grid to a power system and effectively operate the renewable energy.

In order to accomplish the above objects, the present invention provides a vehicle energy harvesting apparatus, including: a battery unit formed in a vehicle; an energy collection unit provided on one side of the vehicle, and configured to generate renewable power by collecting renewable energy; an external charging interface formed on one side of the vehicle in order to exchange power between the battery unit and a smart grid; and an energy management unit configured to perform control such that the renewable power of the energy collection unit is stored in the battery unit, and such that power is exchanged between the battery unit and the smart grid using the external charging interface.

Here, the energy management unit may perform control such that power is supplied from the smart grid to the battery unit when the power level of the battery unit is less than a minimum required power level, and performs control such that power is supplied from the battery unit to the smart grid when the power level of the battery unit is greater than a maximum required power level.

Here, the energy management unit may perform control such that power is supplied from the smart grid to the battery unit or from the battery unit to the smart grid up to the charging required power level of the battery unit.

Here, the energy management unit may perform control such that the battery unit is used as a device for storing surplus power generated by the smart grid in an amount obtained by subtracting a maximum required power level from the available storage power level of the battery unit.

Here, the energy management unit may determine whether to use battery unit as the device for storing the surplus power based on the selection of a user.

Here, the vehicle energy harvesting apparatus may further include an integrated power conversion unit for collecting power supplied from the energy collection unit and the external charging interface, and integrating and transmitting the power to the battery unit.

Here, the energy collection unit may include a plurality of elements used to generate the renewable power; and the integrated power conversion unit may include a plurality of power conversion units corresponding to the plurality of elements and the external charging interface, respectively.

Here, the battery unit may include a plurality of battery cells; and the energy management unit may perform control such that the number of operating battery cells of the plurality of battery cells is adjusted in consideration of the amplitude of the power collected by the integrated power conversion unit.

Here, the battery unit may include a first battery unit and a second battery unit; and the energy management unit may perform control such that the first battery unit and the second battery unit are alternatively charged and discharged.

Here, the energy collection unit may collect the renewable energy using at least one of a thermoelectric element formed in the engine of the vehicle, the inside of a door, or a muffler; a piezoelectric element formed in the engine of the vehicle, a suspension, or a seat; and a solar power element formed in the outside of a body of the vehicle.

In order to accomplish the above objects, the present invention provides a method of managing the energy of a vehicle energy harvesting apparatus, including generating renewable power by collecting renewable energy using an energy collection unit provided on one side of a vehicle; storing the renewable power in the battery unit of the vehicle; and exchanging power between the battery unit and a smart grid using an external charging interface.

Here, exchanging the power may include supplying power from the smart grid to the battery unit when the power level of the battery unit is less than a minimum required power level; and supplying power from the battery unit to the smart grid when the power level of the battery unit is greater than a maximum required power level.

Here, the exchanging the power may include performing control such that power is supplied from the smart grid to the battery unit or from the battery unit to the smart grid up to the charging required power level of the battery unit.

Here, the method may further include transmitting information about the power level of the battery unit to the personal terminal of a user when the power level of the battery unit is less than the minimum required power level or the power level of the battery unit is greater than the maximum required power level.

Here, the method may further include storing surplus power generated by the smart grid in the battery unit.

Here, the storing surplus power in the battery unit may include selecting a specific area in which the demand of power is expected at a specific time in statistics; searching for a target vehicle which can access the smart grid at the specific time and the specific area and which will be used to store the power; and storing the surplus power of the smart grid in the target vehicle.

Here, the method may further include supplying the surplus power stored in the target vehicle to the smart grid.

Here, the storing the surplus power in the battery unit may include performing control such that the battery unit is used as a device for storing the surplus power generated by the smart grid in an amount obtained by subtracting a maximum required power level from the available storage power level of the battery unit.

Here, the storing the surplus power in the battery unit may include determining whether to perform progression based on the selection of the user.

Here, the energy collection unit may collect the renewable energy using at least one of a thermoelectric element formed in the engine of the vehicle, the inside of a door, or a muffler; a piezoelectric element formed in the engine of the vehicle, a suspension, or a seat; and a solar power element formed in the outside of the body of the vehicle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a vehicle energy harvesting apparatus according to the present invention;

FIG. 2 is a view illustrating an example of the energy collection unit of the vehicle energy harvesting apparatus according to the present invention;

FIG. 3 is a view illustrating the operation of a battery unit in which charging and discharging are alternatively performed under the control of an energy management unit;

FIG. 4 is a view illustrating an operation of charging the battery unit under the control of the energy management unit;

FIG. 5 is a view illustrating the vehicle energy harvesting apparatus according to the present invention, which is connected to a smart grid;

FIGS. 6A to 6C are views illustrating the conditions of the supply and demand of power between the battery unit and the smart grid;

FIGS. 7 and 8 are flowcharts illustrating a method of managing the energy of the vehicle energy harvesting apparatus according to the present invention; and

FIG. 9 is a flowchart illustrating a method of storing the surplus power of the smart grid in the battery unit of the vehicle according to the method of managing the energy of the vehicle energy harvesting apparatus of the present invention.

### DESCRIPTION OF THE PREFERRED EMBODIMENTS

The present invention will be described in detail with reference to the accompanying drawings below. Here, when the description is repetitive and detailed descriptions of well-known functions or configurations would unnecessarily obscure the gist of the present invention, the detailed descriptions will be omitted. The embodiments of the present invention are provided to complete the explanation for those skilled in the art the present invention. Therefore, the shapes and sizes of components in the drawings may be exaggerated to provide a more exact description.

The configuration and operation of a vehicle energy harvesting apparatus according to the present invention will be described below.

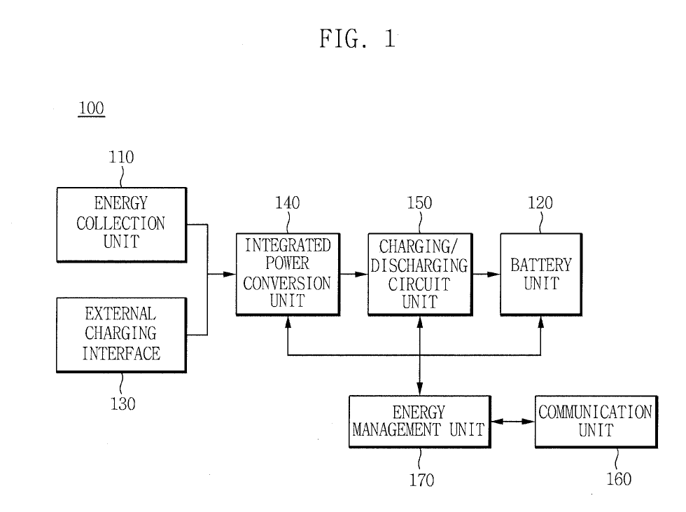

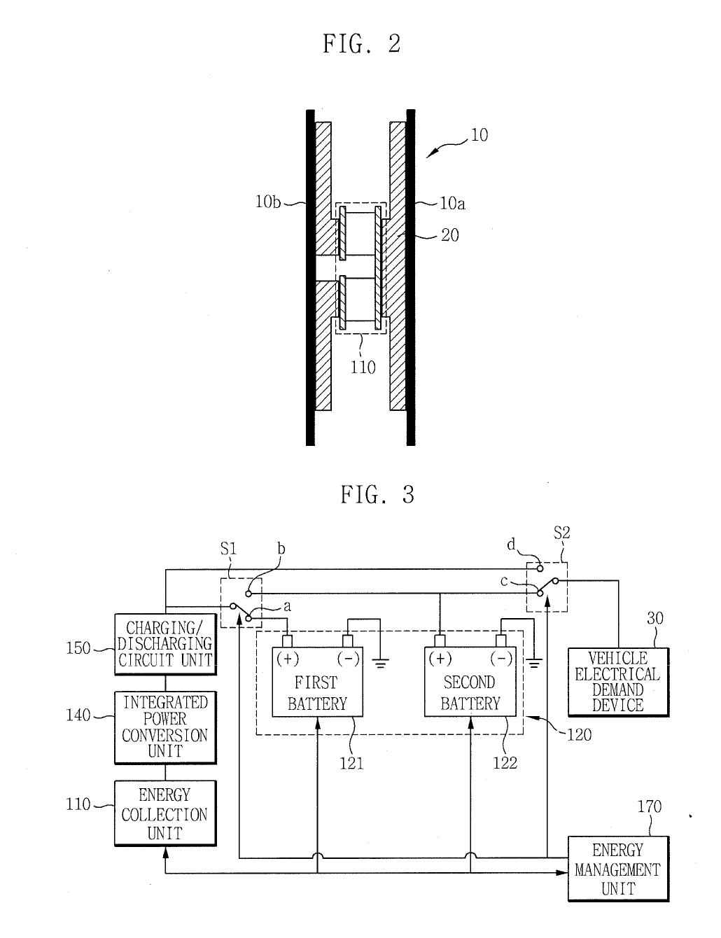

FIG. 1 is a block diagram illustrating the configuration of a vehicle energy harvesting apparatus according to the present invention. FIG. 2 is a view illustrating an example of the energy collection unit of the vehicle energy harvesting apparatus according to the present invention.

Referring to FIG. 1, a vehicle energy harvesting apparatus 100 according to the present invention includes an energy collection unit 110, a battery unit 120, an external charging interface 130, and an energy management unit 170. Further, the vehicle energy harvesting apparatus 100 according to the present invention may further include an integrated power conversion unit 140, a charging/discharging circuit unit 150, and a communication unit 160.

The energy collection unit 110 is provided on one side of a vehicle. Further, the energy collection unit 110 generates renewable power by collecting renewable energy. The energy collection unit 110 may be a thermoelectric element which is formed in the engine of the vehicle, the inside of a door, or a muffler. The thermoelectric element collects the waste heat from the vehicle. Further, the energy collection unit 110 may be a piezoelectric element formed in the engine, suspension, or seat of the vehicle, which violently shakes. Further, the energy collection unit 110 may be a solar power generation element provided on the outside of the vehicle frame.

Referring to FIG. 2, the energy collection unit 110 according to the embodiment of the present invention may be a thermoelectric element formed on the inside of a vehicle door 10. The difference in temperature between the inside and outside of a vehicle may be equal to or higher than 80□ in hot weather. Therefore, a thermoelectric element may be formed as the energy collection unit 110 between the outside 10a and inside 10b of the vehicle door. Further, the thermoelectric element may be formed between the outside 10a and inside 10b of the vehicle door together with a high-thermal conductivity material 20.

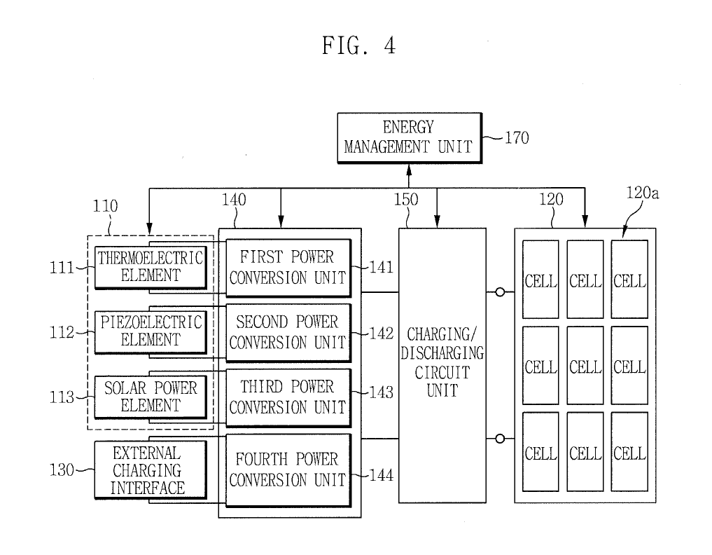

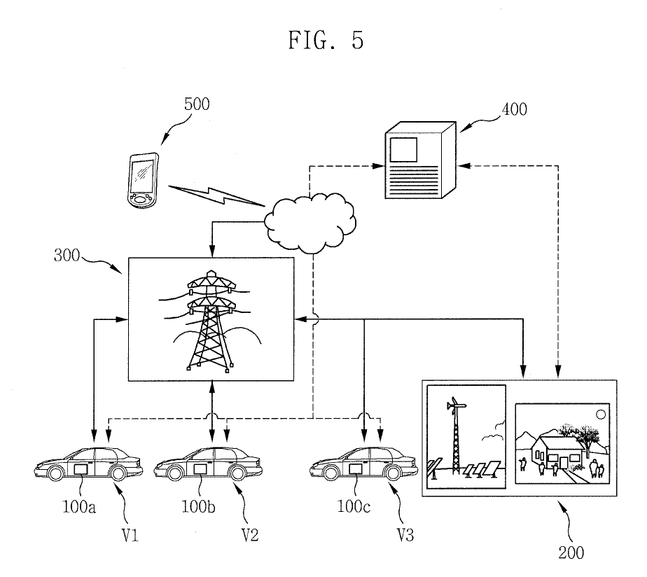

The battery unit 120 is formed in the vehicle. The battery unit 120 may be a high-capacity battery which is used for a hybrid vehicle and an electric vehicle. Further, the battery unit 120 stores the renewable power generated by the energy collection unit 100. Further, the battery unit 120 may store the surplus power generated by a smart grid. The battery unit 120 may include a first battery unit and a second battery unit, that is, a plurality of battery cells. The battery unit will be described in detail with reference to FIGS. 3 and 4 below.

The external charging interface 130 is formed on one side of the vehicle in order to exchange power between the battery unit 120 and the external smart grid. That is, power is provided from the smart grid to the battery unit 120 or from the battery unit 120 to the smart grid through the external charging interface 130.

The integrated power conversion unit 140 collects power provided from the energy collection unit 110 and the external charging interface 130, and then integrally provides the power to the battery unit 120. That is, the integrated power conversion unit 140 converts power provided from the energy collection unit 110 and the external charging interface 130 into power in the state in which it can be used in the vehicle and the smart grid.

The charging/discharging circuit unit 150 stores power obtained through the conversion performed by the integrated power conversion unit 140 in the battery unit 120.

The communication unit 160 functions as a communication interface between the power management server of the smart grid and the energy management unit 170 which will be described later. Further, the communication unit 160 functions as a communication interface between a personal terminal and the energy management unit 170. The communication unit 160 enables wired/wireless communication using various types of communication methods, such as Power Line Communication (PLC), Wave, Wireless Broadband (WiBro), WiFi, and Channel Division Multiple Access (CDMA).

The energy management unit 170 performs control such that the renewable power of the energy collection unit 110 is stored in the battery unit 120. Further, the energy management unit 170 monitors the amount of power stored in the battery unit 120 and the amount of power transmitted from the integrated power conversion unit 140 to the battery unit 120.

Further, the energy management unit 170 performs control such that power is mutually exchanged between the battery unit 120 and the smart grid through the external charging interface 130. In particular, the energy management unit 170 performs control such that power is provided from the smart grid to the battery unit 120 when the power level of the battery unit 120 is less than a minimum required power level. Further, the energy management unit 170 performs control such that power is provided from the battery unit 120 to the smart grid, when the power level of the battery unit 120 is greater than a maximum required power level. Here, the energy management unit 170 may perform control such that the power is supplied from the smart grid to the battery unit 120 or from the battery unit 120 to the smart grid up to the preset power level of the battery unit 120, at which charging is required (hereinafter referred to as “charging required power level”). Here, the minimum required power level, the maximum required power level, and the charging required power level may be preset by a user. Further, the charging required power level may be a value between the minimum required power level and the maximum required power level.

Further, the energy management unit 170 may perform control such that the battery unit 120 can be used as a device for storing the surplus power generated by the smart grid. That is, the energy management unit 170 communicates with the power management server of the smart grid, and performs control such that the surplus power generated by the smart grid is stored in the battery unit 120. Here, the energy management unit 170 may perform control such that the battery unit 120 is used as a device for storing surplus power in an amount obtained by subtracting a maximum required power level from an available storage power level.

Further, the energy management unit 170 may adjust the number of battery cells that will be charged when the battery unit 120 is charged, wherein the battery unit 120 includes a plurality of battery cells. Further, the energy management unit 170 may control the battery unit 120 such that each of the battery cells of the battery unit 120 is alternatively charged and discharged. The charging and discharging of the battery cells will be described with reference to FIGS. 3 and 4.

The configuration and operation related to the charging and discharging of the battery unit of the vehicle energy harvesting apparatus according to the present invention will be described below.

FIG. 3 is a view illustrating the operation of a battery unit in which charging and discharging are alternatively performed under the control of an energy management unit. FIG. 4 is a view illustrating an operation of charging the battery unit under the control of the energy management unit.

Referring to FIG. 3, the battery unit 120 includes a first battery 121 and a second battery 122. Further, the energy management unit 170 controls the energy collection unit 110, the battery unit 120, the integrated power conversion unit 140, and the charging/discharging circuit unit 150. Here, the energy management unit 170 may perform control such that the first battery 121 and the second battery 122 are alternatively charged and discharged. The energy management unit 170 controls a first switch S1 and a second switch S2 such that the first switch S1 comes into contact with a node a and the second switch S2 comes into contact with a node c. Therefore, renewable power generated by the energy collection unit 110 is stored in the first battery 121 through the integrated power conversion unit 140 and the charging/discharging circuit unit 150. Further, power which is charged in the second battery 122 is discharged through a vehicle electrical demand device 30. Thereafter, when the first battery 121 is completely charged and a predetermined level of the second battery 122 has been discharged, the energy management unit 170 controls the first switch S1 and the second switch S2 such that the first switch S1 comes into contact with a node b and the second switch S2 comes into contact with a node d. Therefore, the charging of the second battery 122 and the discharging of the first battery 121 start. As described above, the energy management unit 170 allows the battery unit 120 to be divided into a power collection battery and a power provision battery and then to be operated according to the division. With the above-described operation, the phenomenon of the polarity reversal of the battery unit 120 is minimized, and the lifetime of the battery unit 120 can be extended.

Referring to FIG. 4, the energy collection unit 110 includes a plurality of elements, that is, a thermoelectric element 111, a piezoelectric element 112, and a solar power element 113. Further, the battery unit 120 includes a plurality of battery cells 120a. Further, the integrated power conversion unit 140 includes a first power conversion unit 141, a second power conversion unit 142, a third power conversion unit 143, and a fourth power conversion unit 144. The energy management unit 170 controls the operations of the energy collection unit 110, the battery unit 120, the external charging interface 130, the integrated power conversion unit 140, and the charging/discharging circuit unit 150. Here, the first power conversion unit 141, the second power conversion unit 142, the third power conversion unit 143, and the fourth power conversion unit 144 may independently operate with the plurality of elements of the energy collection unit 110 and the external charging interface 130. That is, the first power conversion unit 141 may be connected to the thermoelectric element 111, the second power conversion unit 142 may be connected to the piezoelectric element 112, the third power conversion unit 143 may be connected to the solar power element 113, and the fourth power conversion unit 144 may be connected to the external charging interface 130. That is, the thermoelectric element 111, the piezoelectric element 112, the solar power element 113, and the external charging interface 130 have electromotive forces which are different from each other. Therefore, when power conversion is performed using a single power conversion unit, the efficiency of power conversion decreases. In order to solve the above-described problem, operation is performed in such a way that separate power conversion units are connected to the respective elements of the energy collection unit 110 and the external charging interface 130.

Further, the energy management unit 170 may control the battery unit 120 such that the number of the operating battery cells from among the plurality of battery cells 120a can be adjusted in consideration of the amplitude of the power collected by the integrated power conversion unit 140. Generally, although the battery is charged using a constant-current method or a constant-voltage method, the amount of generated energy which is collected by the energy collection unit 110 varies depending on circumstances. That is, in a cloudy weather, the thermoelectric element 111 and the piezoelectric element 112 produce electricity but the solar power element 113 cannot produce electricity. Therefore, the energy management unit 170 monitors power and current which are provided from the integrated power conversion unit 140 to the battery unit 120, and adjusts the number of battery cells 120a which will be charged such that the use of the provided power and current can be optimized. For example, when it is assumed that power used to charge a unit battery cell 120a is 100 W and the amount of power provided from the integrated power conversion unit 140 is 500 W, the energy management unit 170 may perform control such that only five battery cells 120a of the battery unit 120 are activated for charging. Thereafter, when the amount of power provided from the integrated power conversion unit 140 is changed to 1 kW, the energy management unit 170 may perform control such that ten battery cells 120a of the battery unit 120 can be activated for charging.

The vehicle energy harvesting apparatus according to the present invention, which is connected to the smart grid, and the conditions of the supply and demand of power between the battery unit and the smart grid will be described below.

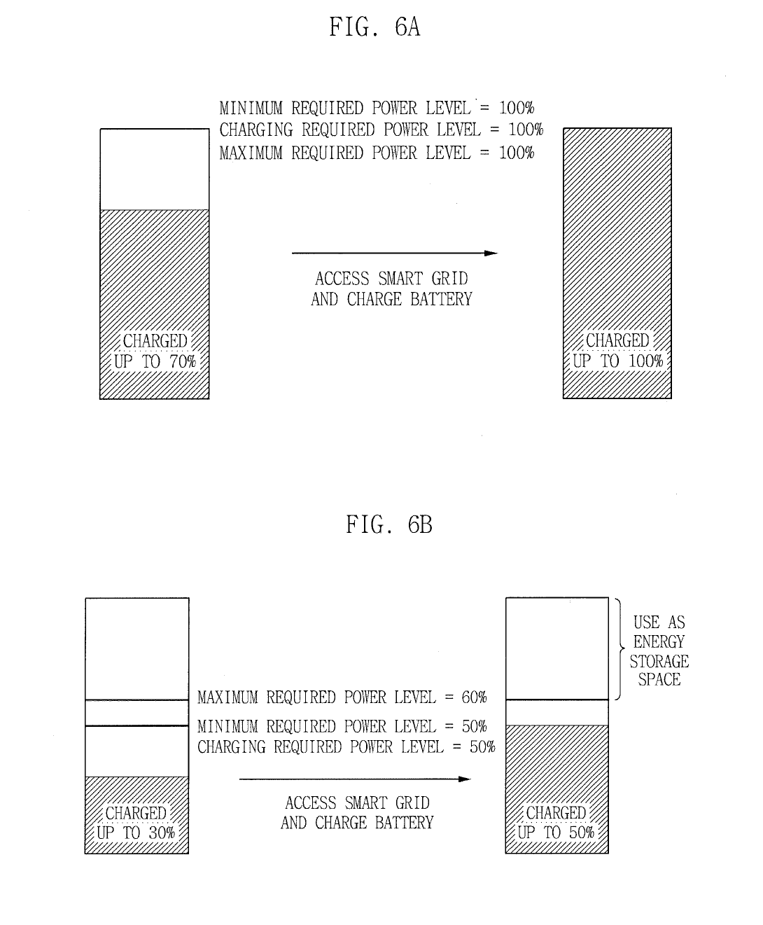

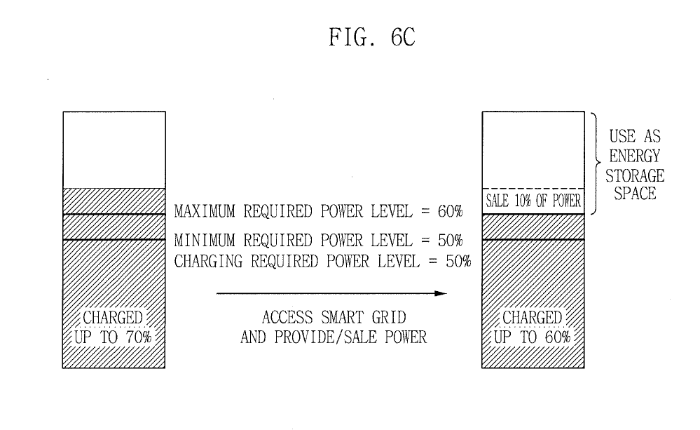

FIG. 5 is a view illustrating the vehicle energy harvesting apparatus according to the present invention, which is connected to a smart grid. FIGS. 6A to 6C are views illustrating the conditions of the supply and demand of power between the battery unit and the smart grid.

Referring to FIG. 5, the dotted lines indicate the flow of information and the solid lines indicate the flow of power. A plurality of vehicles V1, V2, and V3 are provided with the respective vehicle energy harvesting apparatuses according to the present invention 100a, 100b, and 100c. Further, each of the vehicle energy harvesting apparatuses 100a, 100b, and 100c is formed to be able to communicate with a power management server 400 and a personal terminal 500. Here, the personal terminal 500 may be a mobile device, such as a Personal Computer (PC), a Portable Digital Assistant (PDA), or a smart phone, which can perform network communication. Further, the power management server 400 entirely controls the smart grid, and, in particular, monitors the amount of power generated by renewable energy generation means 200. When information is exchanged between each of the vehicle energy harvesting apparatuses 100a, 100b and 100c and the power management server 400, power stored in the battery unit of each of the plurality of vehicles V1, V2, and V3 can be provided to the smart grid through the power equipment 300. Further, power generated by the smart grid may be provided to the battery unit of each of the plurality of vehicles V1, V2, and V3. Each of the plurality of vehicles V1, V2, and V3 may access a smart grid power network when the vehicle parks. An on-line vehicle capable of exchanging power in a contactless manner may access the smart grid power network in a section where contactless power exchange and wireless communication can be performed.

FIGS. 6A to 6C illustrates the conditions of the supply and demand of power between the battery unit of the vehicle energy harvesting apparatus and the smart grid. The energy management unit and the power management server perform control such that the supply and demand of power are performed between the battery unit and the smart grid based on the preset minimum required power level, the charging required power level, and the maximum required power level. That is, the energy management unit and the power management server perform control such that power is supplied from the smart gid to the battery unit when the power level of the battery unit is less than the minimum required power level. Further, the energy management unit and the power management server perform control such that power is supplied from the battery unit to the smart grid when the power level of the battery unit is greater than the maximum required power level. Further, the energy management unit and the power management server perform control such that power is supplied from the smart grid to the battery unit or from the battery unit to the smart grid up to the charging required power level of the battery unit.

Referring to FIG. 6A, all of the minimum required power level, the charging required power level and the maximum required power level of the battery unit are set to 100%. Further, the battery unit is charged up to 70% of an available storage power level. Here, the energy management unit accesses the smart grid using the power management server, and performs control such that power is supplied from the smart grid to the battery unit. Further, when the charging level of the battery unit is the same as the charging required power level, the energy management unit stops supplying the power from the smart grid to the battery unit.

Referring to FIG. 6B, the minimum required power level and charging required power level of the battery unit are set to 50%. Further, the maximum required power level of the battery unit is set to 60%. Further, the battery unit is charged up to 30% of the available storage power level. Here, the energy management unit accesses the smart grid using the power management server, and performs control such that power is supplied from the smart grid to the battery unit. Further, when the charging level of the battery unit is the same as the charging required power level, the energy management unit stops supplying the power from the smart grid to the battery unit.

Referring to FIG. 6C, the minimum required power level and charging required power level of the battery unit are set to 50%. Further, the maximum required power level of the battery unit is set to 60%. Further, the battery unit is charged up to 70% of the available storage power level. Here, the energy management unit accesses the smart grid using the power management server, and performs control such that power is supplied from the battery unit to the smart grid. Further, when the charging level of the battery unit is the same as the charging required power level or the maximum required power level, the energy management unit stops supplying the power from the battery unit to the smart grid.

Further, in FIGS. 6B and 6C, the amount (40%), obtained by subtracting the maximum required power level from the available storage power level of the battery unit, may be used for the device for storing surplus power generated by the smart grid.

A method of managing the energy of the vehicle energy harvesting apparatus according to the present invention will be described below.

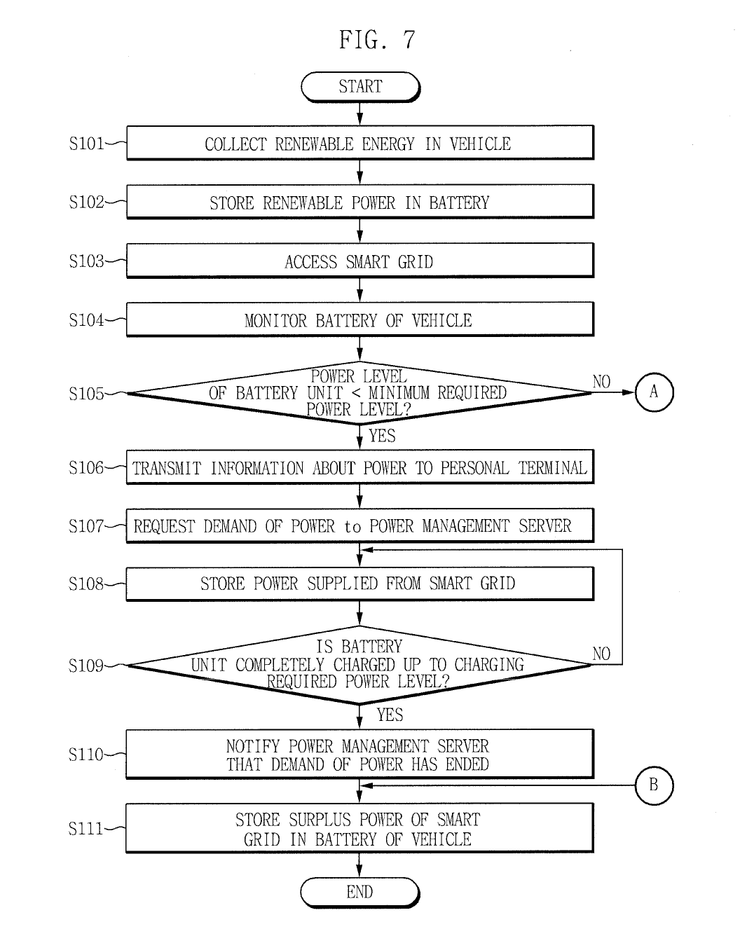

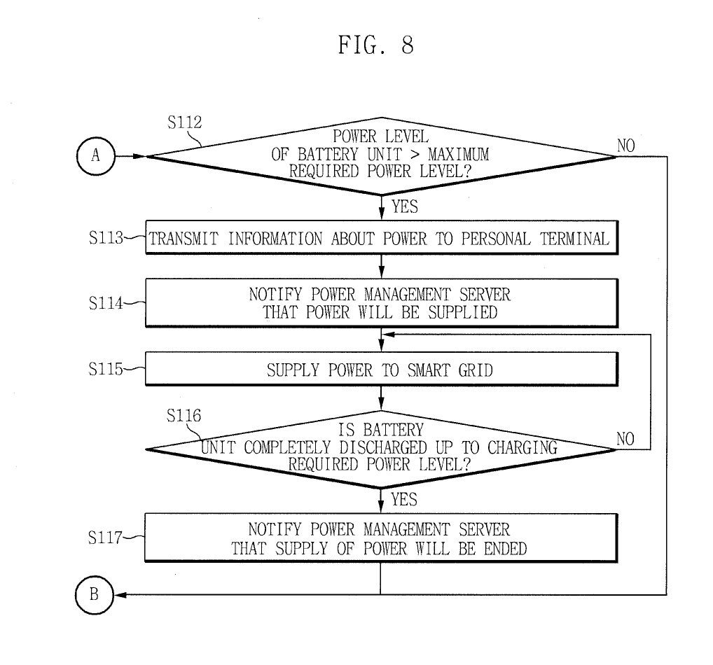

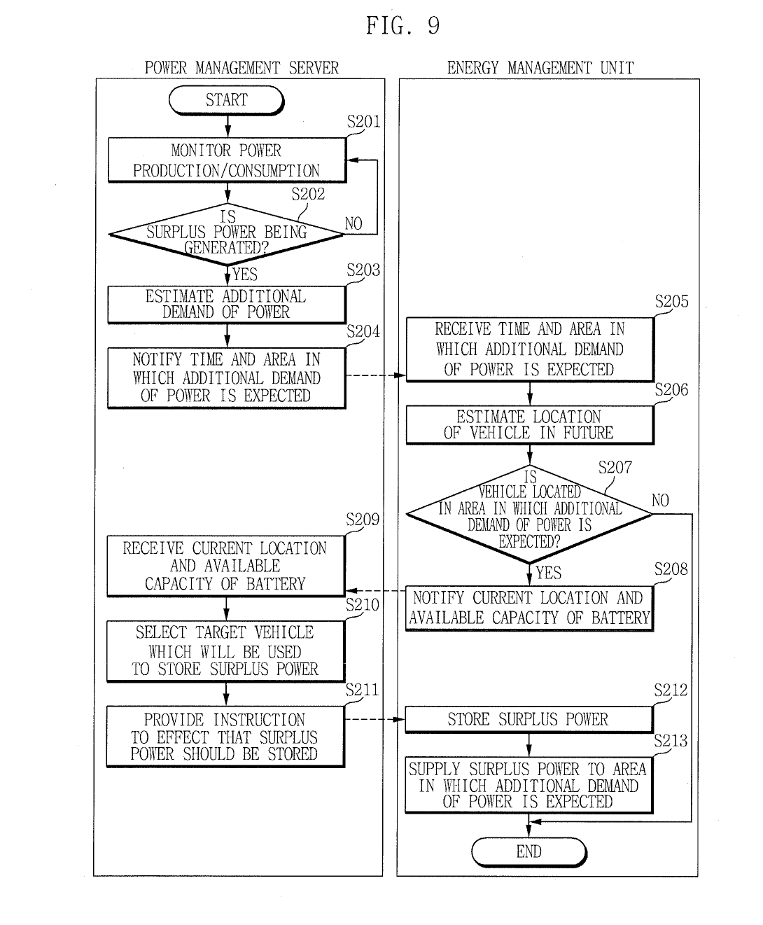

FIGS. 7 and 8 are flowcharts illustrating the operation of a method of managing the energy of the vehicle energy harvesting apparatus according to the present invention. FIG. 9 is a flowchart illustrating a method of storing the surplus power of the smart grid in the battery unit of the vehicle according to the method of managing the energy of the vehicle energy harvesting apparatus of the present invention.

Referring to FIGS. 7 and 8, in the method of managing the energy of the vehicle energy harvesting apparatus according to the present invention, first, renewable power is generated by collecting renewable energy using the energy collection unit of the vehicle energy harvesting apparatus, which is provided on one side of the vehicle at step S101.

Thereafter, renewable power, which was generated at step S101, is stored in the battery unit of a vehicle at step S102.

The energy management unit of the vehicle energy harvesting apparatus accesses the power management server of the smart grid, and enables the vehicle energy harvesting apparatus to access the smart grid at step S103.

Thereafter, the energy management unit continuously monitors information about the power of the battery unit of the vehicle at step S104. Here, it is determined whether the power level of the battery unit is less than a preset minimum required power level at step S105.

If, as the result of the determination at step S105, the power level of the battery unit is less than a preset minimum required power level, information about the power level of the battery unit may be transmitted to the personal terminal of a user under the control of the energy management unit at step S106.

Further, if, as the result of the determination at step S105, the power level of the battery unit is less than a preset minimum required power level, the energy management unit requests the demand of power from the power management server of the smart grid at step S107.

The power management server, which received the request at step S107, performs control such that power is supplied from the smart grid to the battery unit of the vehicle, and the battery unit stores power which was received from the smart grid at step S108.

Here, it is determined whether the battery unit is completely charged up to the charging required power level of the battery unit at step S109. If, as the result of the determination at step S109, the battery unit is not completely charged up to the charging required power level of the battery unit, the process returns to step S108 and power is continuously received from the smart grid.

Meanwhile, if, as the result of the determination at step S109, the battery unit is completely charged up to the charging required power level of the battery unit, the energy management unit notifies the power management server that the demand of power has ended at step S110.

Thereafter, surplus power generated by the smart grid may be stored in the battery unit of the vehicle at step S111. That is, the battery of the vehicle may be used as the surplus power storage device of the smart grid. Here, whether to progress step S111 may be determined based on the selection of the user. The detailed description of step S111 will be described with reference to FIG. 9 below.

If, as the result of the determination at step S105, the power level of the battery unit is higher than the minimum required power level, it is determined whether the power level of the battery unit is greater than the maximum required power level at step S112. If, as the result of the determination at step S112, the power level of the battery unit is not greater than the maximum required power level, the battery unit may be used as the device for storing surplus power generated by the smart grid using step S111.

Meanwhile, if, as the result of the determination at step S112, the power level of the battery unit is greater than the maximum required power level, information about the power level of the battery unit may be transmitted to the personal terminal of the user at step S113.

Further, if, as the result of the determination at step S112, the power level of the battery unit is greater than the maximum required power level, the energy management unit notifies the power management server of the smart grid that power will be supplied at step S114.

Thereafter, the energy management unit performs control such that power is supplied from the battery unit of the vehicle to the smart grid at step S115.

Here, it is determined whether the battery unit is completely discharged up to the charging required power level of the battery unit at step S116. If, as the result of the determination at step S116, the battery unit is not completely discharged up to the charging required power level of the battery unit, the progress returns to step S115 and power is continuously supplied from the battery unit to the smart grid.

Meanwhile, if, as the result of the determination at step S116, the battery unit is completely discharged up to the charging required power level of the battery unit, the energy management unit notifies the power management server that the supply of the power will be ended at step S117.

Thereafter, surplus power generated by the smart grid may be stored in the battery unit of the vehicle at step S111.

Referring to FIG. 9, in the method of managing energy using the energy harvesting apparatus according to the present invention, a method of storing the surplus power of the smart grid in the battery unit of the vehicle will be described below.

First, the power management server monitors the power production and power consumption of the smart grid at step S201. Thereafter, the power management server determines whether surplus power is being generated in the smart grid at step S202. If, as the result of the determination at step S202, it is determined that surplus power is not being generated, the power management server continuously monitors the power production and power consumption of the smart grid. Meanwhile, if, as the result of the determination at step S202, it is determined that surplus power is being generated, the power management server selects a specific area in which the additional demand of power is expected at a specific time in the statistics at step S203. Thereafter, the power management server transmits information about the specific time and the specific area, in which the additional demand of power is expected, to the energy management unit of the vehicle energy harvesting apparatus of each of the plurality of vehicles at step S204.

Thereafter, the power management server searches for a target vehicle which can access the smart grid at the specific time and the specific area and which will be used to store power. That is, the energy management unit receives information about the specific time and the specific area, obtained at step S204, at step S205. Thereafter, the power management server determines whether each of the vehicles will be located at the specific time and the specific area, where the additional demand of power is estimated, in the statistics or based on each of traveling paths input by the user at step S206. Thereafter, the power management server determines whether the vehicle will be located at the specific time and at the specific area, that is, the area in which the additional demand of power is expected at step S207. If, as the result of the determination at step S207, it is determined that the corresponding vehicle will be located at the specific time and the specific area, the energy management unit transmits information about the current location and the available capacity of the battery of the corresponding vehicle to the power management server at step S208.

The power management server receives the information about the current location and the available capacity of the battery of the corresponding vehicle, obtained at step S208, at step S209. Thereafter, the power management server selects the corresponding vehicle as the target vehicle which will be used to store surplus power at step S210. Further, the power management server provides instructions to the effect that the surplus power of the smart grid should be stored in the battery unit of the vehicle energy harvesting apparatus at step S211.

After step S211 is performed, the energy management unit performs control such that the surplus power of the smart grid is stored in the battery unit of the vehicle energy harvesting apparatus at step S212. Thereafter, the target vehicle, which will be used to store power, supplies the surplus power stored in the battery unit at the specific time and the specific area in the future at step S213.

According to the present invention, environmental energy and energy which was discarded from a vehicle may be effectively collected.

Further, the present invention connects the high-capacity battery of a vehicle to a smart grid, thereby enabling power to be effectively and intelligently stored, operated, and managed.

Further, the present invention enables the high-capacity battery of a vehicle to be used as a device for storing power produced by an apparatus for generating renewable energy in which the estimation and adjustment of the amount of generating power are difficult. That is, the present invention may enable the high-capacity battery of a vehicle to be used as a device for storing surplus power generated by a smart grid.

Further, the present invention enables renewable energy generated by a smart grid to be stably provided to a power system, thereby effectively operating the renewable energy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vehicle energy harvesting apparatus, comprising:
a battery unit formed in a vehicle;
an energy collection unit provided on one side of the vehicle, and configured to generate renewable power by collecting renewable energy;
an external charging interface formed on one side of the vehicle in order to exchange power between the battery unit and a smart grid; and
an energy management unit configured to perform control such that the renewable power of the energy collection unit is stored in the battery unit, and such that power is exchanged between the battery unit and the smart grid using the external charging interface.

2. The vehicle energy harvesting apparatus as set forth in claim 1, wherein the energy management unit performs control such that power is supplied from the smart grid to the battery unit when a power level of the battery unit is less than a minimum required power level, and performs control such that power is supplied from the battery unit to the smart grid when the power level of the battery unit is greater than a maximum required power level.

3. The vehicle energy harvesting apparatus as set forth in claim 2, wherein the energy management unit performs control such that power is supplied from the smart grid to the battery unit or from the battery unit to the smart grid up to a charging required power level of the battery unit.

4. The vehicle energy harvesting apparatus as set forth in claim 1, wherein the energy management unit performs control such that the battery unit is used as a device for storing surplus power generated by the smart grid in an amount obtained by subtracting a maximum required power level from an available storage power level of the battery unit.

5. The vehicle energy harvesting apparatus as set forth in claim 4, wherein the energy management unit determines whether to use battery unit as the device for storing the surplus power based on selection of a user.

6. The vehicle energy harvesting apparatus as set forth in claim 1, further comprising an integrated power conversion unit for collecting power supplied from the energy collection unit and the external charging interface, and integrating and transmitting the power to the battery unit.

7. The vehicle energy harvesting apparatus as set forth in claim 6, wherein:
the energy collection unit comprises a plurality of elements used to generate the renewable power; and
the integrated power conversion unit comprises a plurality of power conversion units corresponding to the plurality of elements and the external charging interface, respectively.

8. The vehicle energy harvesting apparatus as set forth in claim 6, wherein:
the battery unit comprises a plurality of battery cells; and
the energy management unit performs control such that a number of operating battery cells of the plurality of battery cells is adjusted in consideration of an amplitude of the power collected by the integrated power conversion unit.

9. The vehicle energy harvesting apparatus as set forth in claim 1, wherein the battery unit comprises a first battery unit and a second battery unit; and
the energy management unit performs control such that the first battery unit and the second battery unit are alternatively charged and discharged.

10. The vehicle energy harvesting apparatus as set forth in claim 1, wherein the energy collection unit collects the renewable energy using at least one of:
a thermoelectric element formed in an engine of the vehicle, an inside of a door, or a muffler;
a piezoelectric element formed in the engine of the vehicle, a suspension, or a seat; and
a solar power element formed in an outside of a body of the vehicle.

11. A method of managing energy of a vehicle energy harvesting apparatus, comprising:
generating renewable power by collecting renewable energy using an energy collection unit provided on one side of a vehicle;
storing the renewable power in a battery unit of the vehicle; and
exchanging power between the battery unit and a smart grid using an external charging interface.

12. The method as set forth in claim 11, wherein the exchanging the power comprises:
supplying power from the smart grid to the battery unit when a power level of the battery unit is less than a minimum required power level; and
supplying power from the battery unit to the smart grid when the power level of the battery unit is greater than a maximum required power level.

13. The method as set forth in claim 12, wherein the exchanging the power comprises performing control such that power is supplied from the smart grid to the battery unit or from the battery unit to the smart grid up to a charging required power level of the battery unit.

14. The method as set forth in claim 12, further comprising transmitting information about the power level of the battery unit to a personal terminal of a user when the power level of the battery unit is less than the minimum required power level or the power level of the battery unit is greater than the maximum required power level.

15. The method as set forth in claim 11, further comprising storing surplus power generated by the smart grid in the battery unit.

16. The method as set forth in claim 15, wherein the storing surplus power in the battery unit comprises:
selecting a specific area in which demand of power is expected at a specific time in statistics;
searching for a target vehicle which can access the smart grid at the specific time and the specific area and which will be used to store the power; and
storing the surplus power of the smart grid in the target vehicle.

17. The method as set forth in claim 16, further comprising supplying the surplus power stored in the target vehicle to the smart grid.

18. The method as set forth in claim 15, wherein the storing the surplus power in the battery unit comprises performing control such that the battery unit is used as a device for storing the surplus power generated by the smart grid in an amount obtained by subtracting a maximum required power level from an available storage power level of the battery unit.

19. The method as set forth in claim 15, wherein the storing the surplus power in the battery unit comprises determining whether to perform progression based on selection of the user.

20. The method as set forth in claim 11, wherein the energy collection unit collects the renewable energy using at least one of a thermoelectric element formed in an engine of the vehicle, an inside of a door, or a muffler;
a piezoelectric element formed in the engine of the vehicle, a suspension, or a seat; and
a solar power element formed in an outside of a body of the vehicle.
